(19) United States
(12) Patent Application Publication
(10) Pub. No.: US 2025/0266667 A1
(43) Pub. Date: Aug. 21, 2025

(54) PROTECTOR

(71) Applicant: YAZAKI CORPORATION, Tokyo (JP)

(72) Inventors: Takatatsu Yamamoto, Makinohara-shi (JP); Shigehiko Kobayashi, Makinohara-shi (JP)

(21) Appl. No.: 19/051,183

(22) Filed: Feb. 12, 2025

(30) Foreign Application Priority Data
Feb. 15, 2024 (JP) 2024-020958

(51) Int. Cl. H02G 3/04; H02G 3/06

(52) U.S. Cl. CPC H02G 3/045; H02G 3/0608

(57) ABSTRACT

A protector includes an assembly that forms a groove section in which a wire harness is routed or an assembly that covers the groove section, in which the assembly includes a first engaging body and a second engaging body, the first engaging body includes first engaging sections, the second engaging body is an engaging body disposed side by side with the first engaging body along a width direction of the groove section and includes second engaging section engageable with the first engaging section along an extending direction of the groove section, and the first engaging sections and the second engaging sections are configured to be engageable at different relative positions in the width direction such that the assembly having a different dimension in the width direction can be selectively formed.

### CROSS-REFERENCE TO RELATED APPLICATION(S)

The present application claims priority to and incorporates by reference the entire contents of Japanese Patent Application No. 2024-020958 filed in Japan on Feb. 15, 2024.

### BACKGROUND OF THE INVENTION

### 1. Field of the Invention

The present invention relates to a protector.

### 2. Description of the Related Art

There has been a protector that houses a wire harness. Japanese Patent Application Laid-open No. 2022-128265 discloses a protector including a base section in which a housing recess for allowing a wire harness to pass is formed and a lid section capable of closing the housing recess of the base section.

If dedicated protectors of different sizes are prepared according to the thicknesses of wire harnesses to be housed, an increase in the number of product numbers is caused. It is desirable to be able to implement protectors of different sizes while suppressing an increase in the number of product numbers.

### SUMMARY OF THE INVENTION

An object of the present invention is to provide a protector, the size of which can be adjusted according to the thickness of a wire harness to be housed while suppressing an increase in the number of product numbers.

A protector according to one aspect of the invention includes an assembly that forms a groove section in which a wire harness is routed or an assembly that covers the groove section, wherein the assembly includes a first engaging body and a second engaging body, the first engaging body includes a first engaging section, the second engaging body is an engaging body disposed side by side along a width direction of the groove section with respect to the first engaging body and includes a second engaging section engageable with the first engaging section along an extending direction of the groove section, and the first engaging section and the second engaging section are configured to be engageable at different relative positions in the width direction such that the assembly having a different dimension in the width direction can be selectively formed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a protector according to an embodiment;

FIG. 2 is a side view of the protector according to the embodiment;

FIG. 3 is a perspective view of a main body according to the embodiment;

FIG. 4 is an exploded perspective view of the main body according to the embodiment;

FIG. 5 is a plan view of the main body according to the embodiment;

FIG. 6 is a perspective view of the main body according to the embodiment;

FIG. 7 is a plan view of the main body according to the embodiment;

FIG. 8 is a sectional view of the main body according to the embodiment;

FIG. 9 is a perspective view of the protector according to the embodiment;

FIG. 10 is a perspective view of the protector according to the embodiment;

FIG. 11 is a plan view of a wire harness routed in the main body;

FIG. 12 is an exploded view of the main body according to the embodiment;

FIG. 13 is an exploded view of a cover according to the embodiment;

FIG. 14 is a perspective view of the protector according to the embodiment;

FIG. 15 is an exploded perspective view of the main body according to the embodiment; and

FIG. 16 is an exploded perspective view of the cover according to the embodiment.

### DETAILED DESCRIPTION OF THE PREFERRED EMBODIMENTS

A protector according to an embodiment of the present invention is explained in detail below with reference to the drawings. Note that the present invention is not limited by the embodiment. Components in the embodiment explained below include components that can be easily assumed by those skilled in the art or components that are substantially the same.

### Embodiment

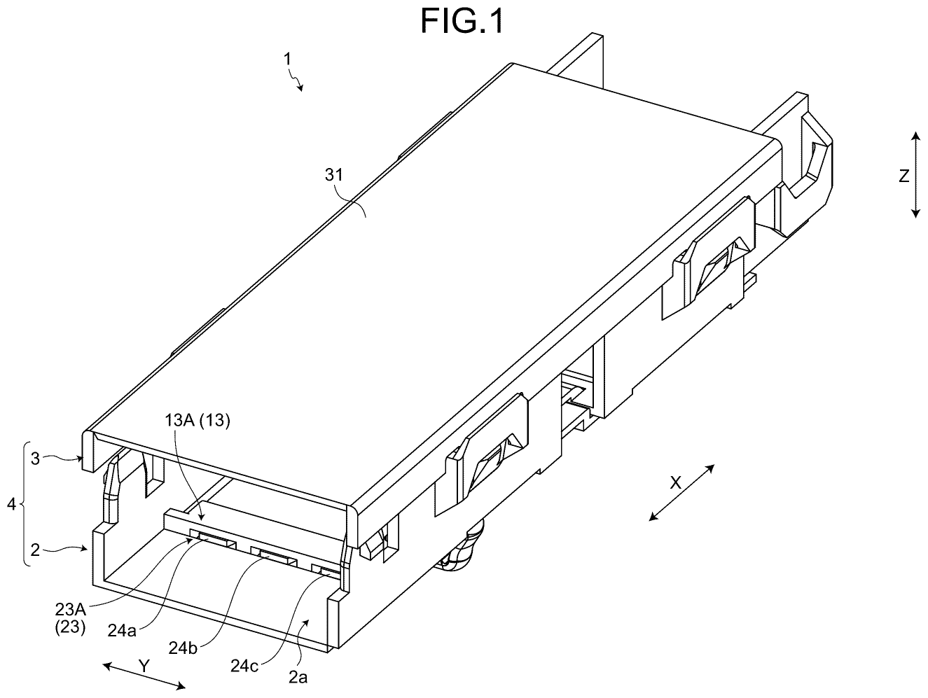

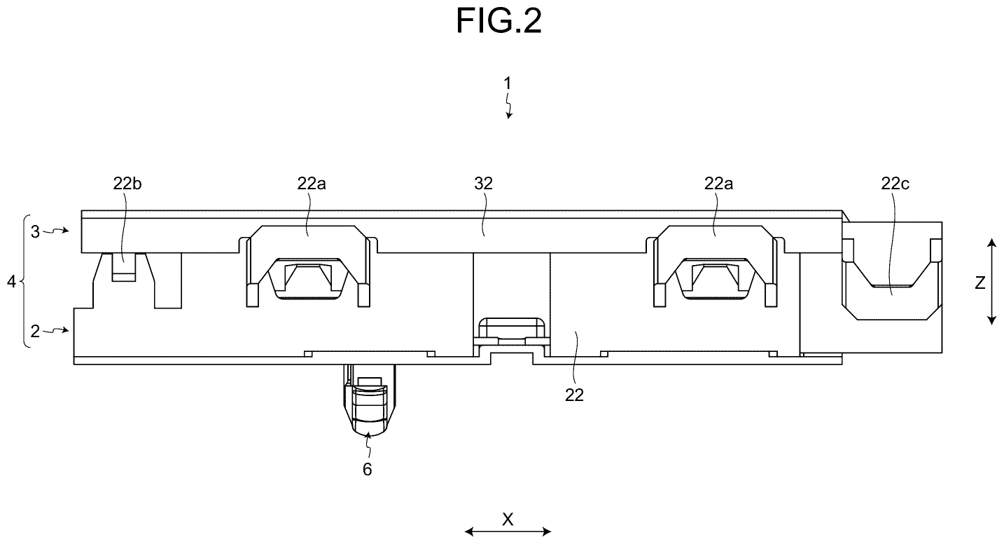

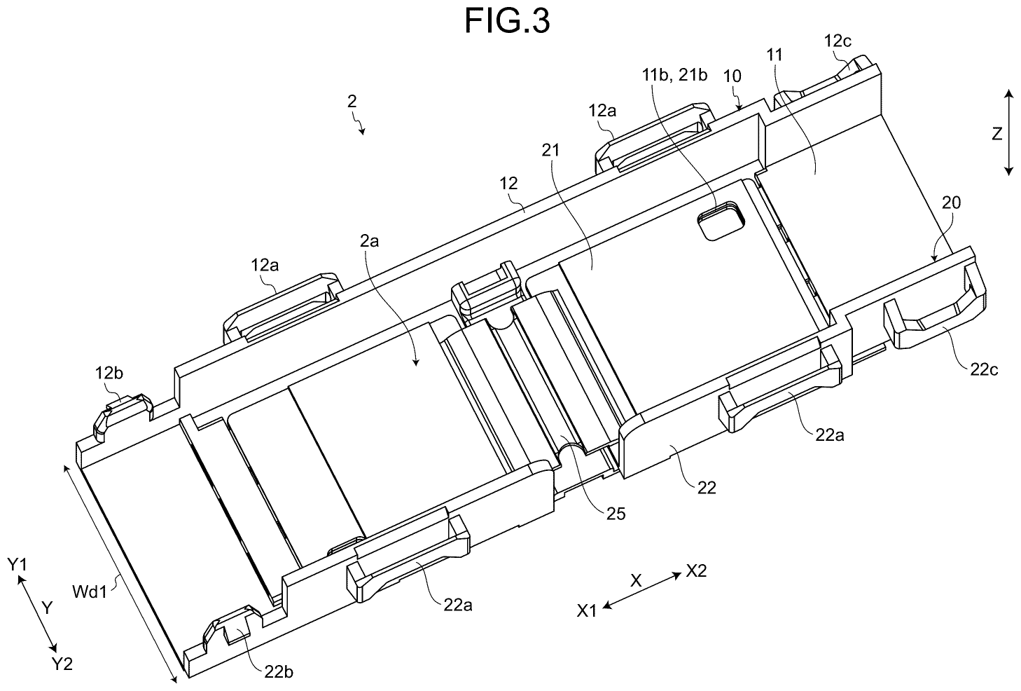

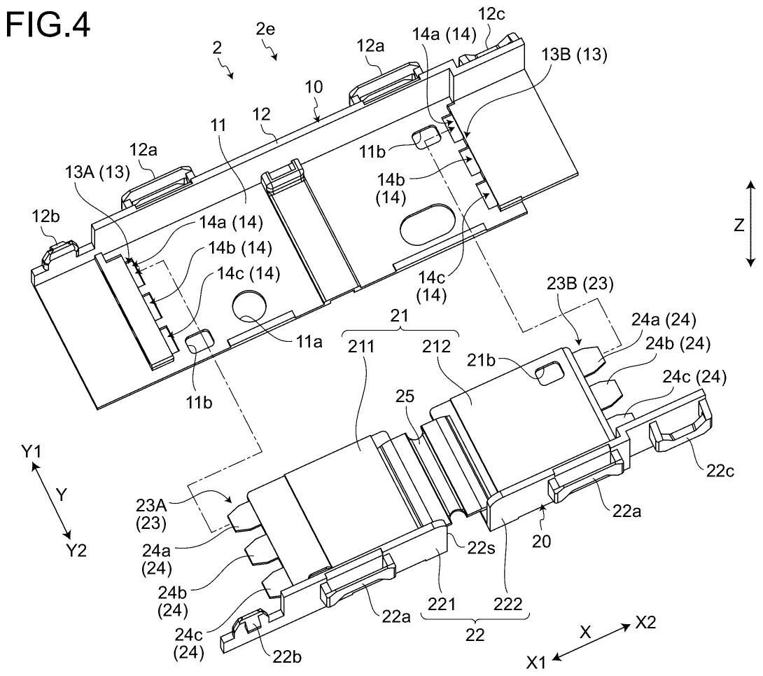

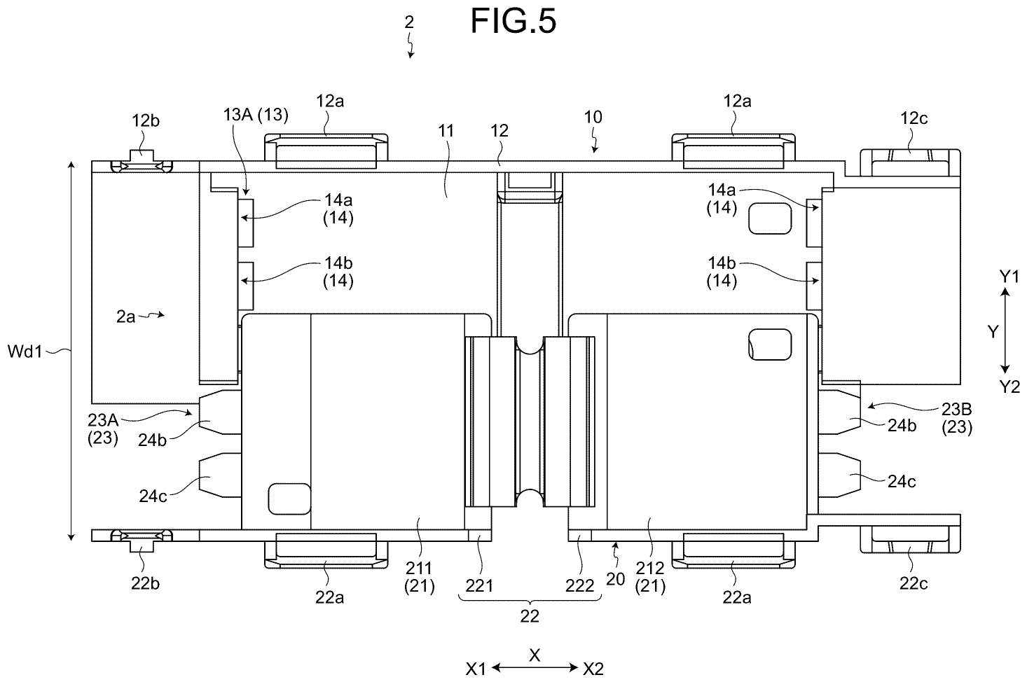

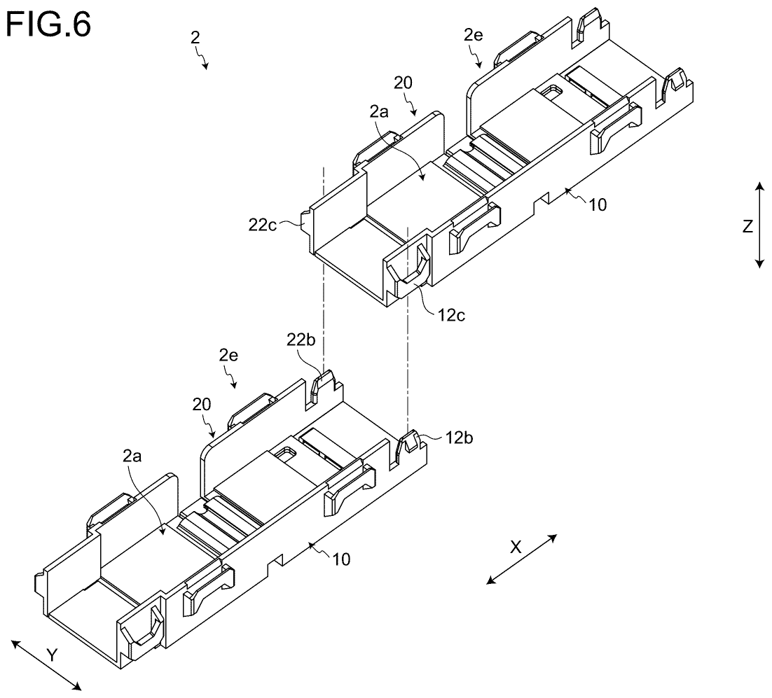

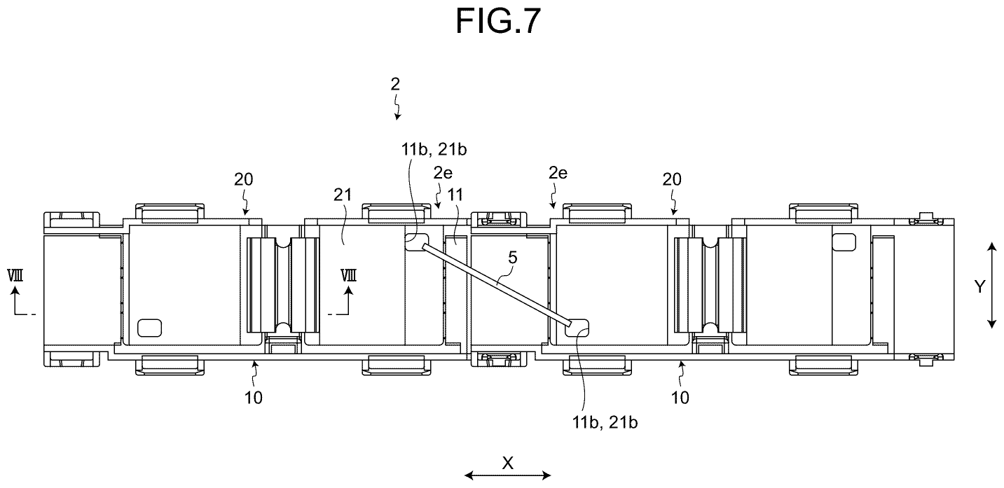

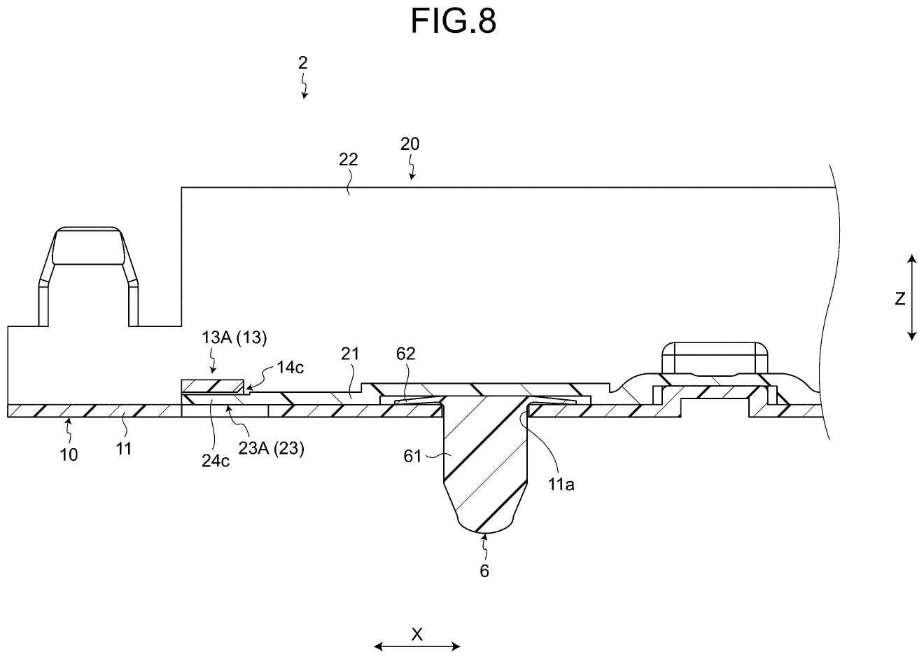

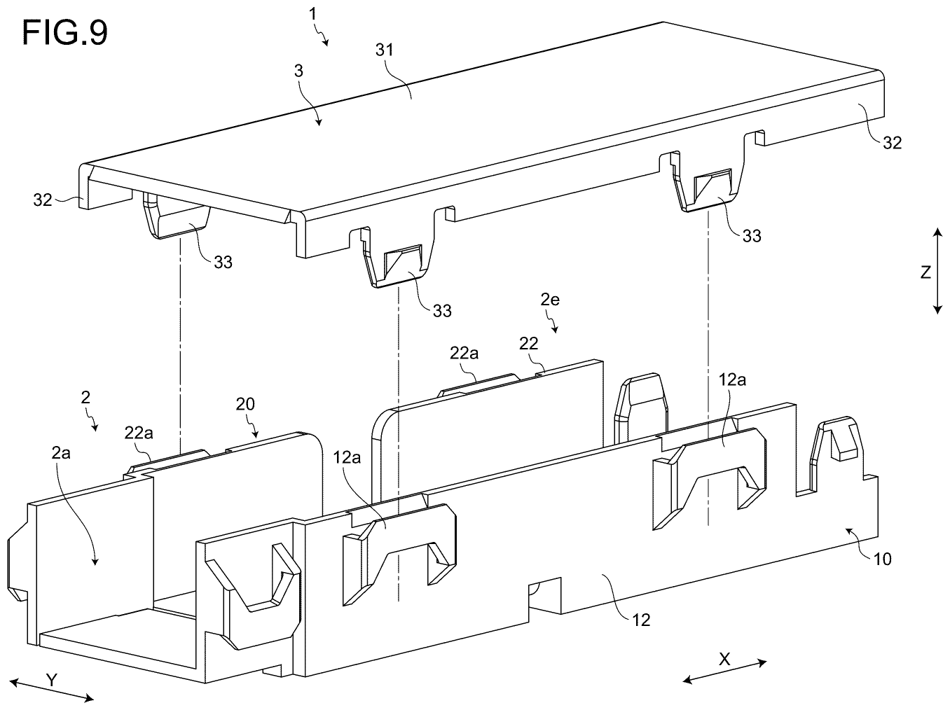

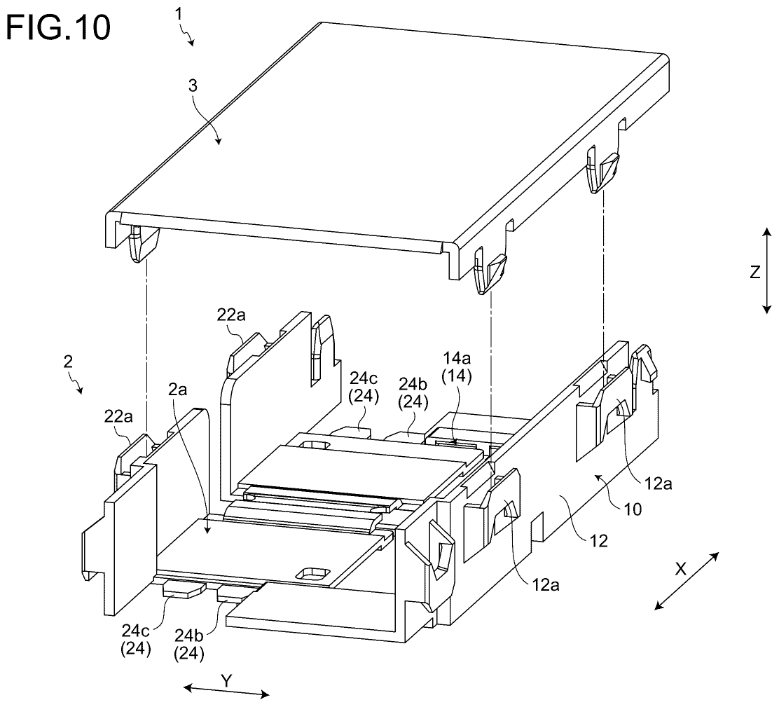

An embodiment is explained with reference to FIG. 1 to FIG. 16. The present embodiment relates to a protector. FIG. 1 is a perspective view of the protector according to the embodiment, FIG. 2 is a side view of the protector according to the embodiment, FIG. 3 is a perspective view of a main body according to the embodiment, FIG. 4 is an exploded perspective view of the main body according to the embodiment, FIG. 5 is a plan view of the main body according to the embodiment, FIG. 6 is a perspective view of the main body according to the embodiment, FIG. 7 is a plan view of the main body according to the embodiment, FIG. 8 is a sectional view of the main body according to the embodiment, and FIG. 9 and FIG. 10 are perspective views of the protector according to the embodiment.

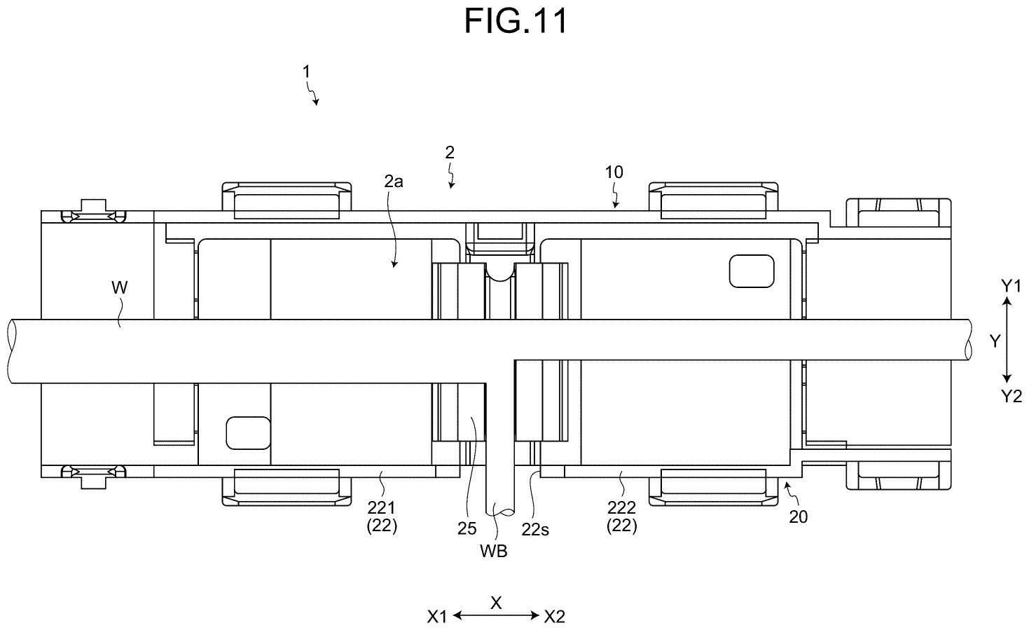

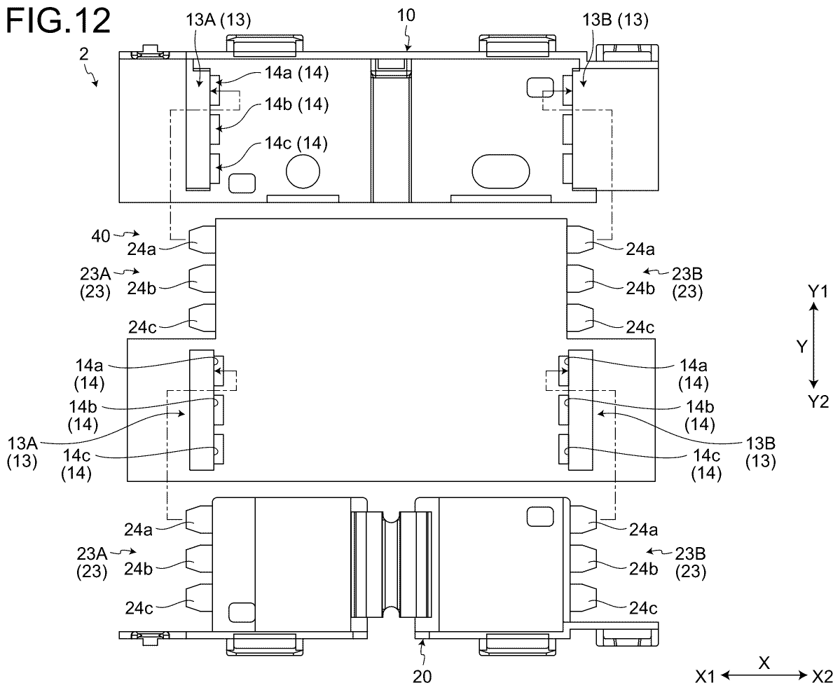

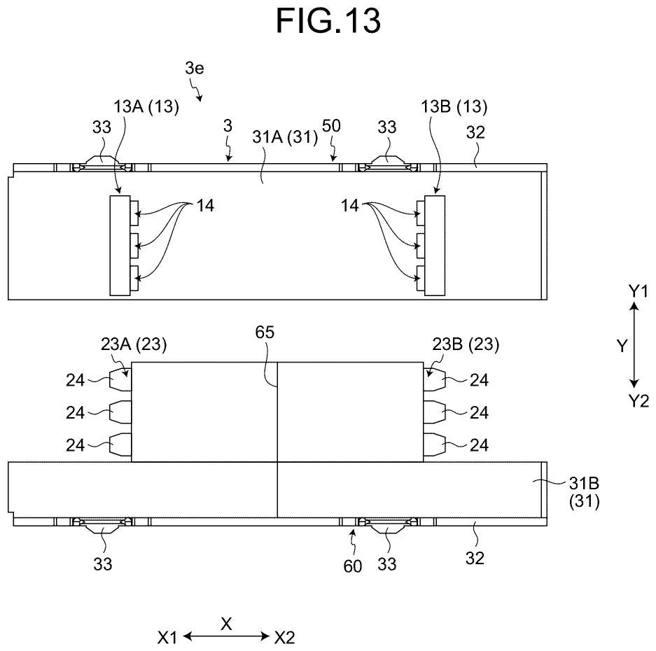

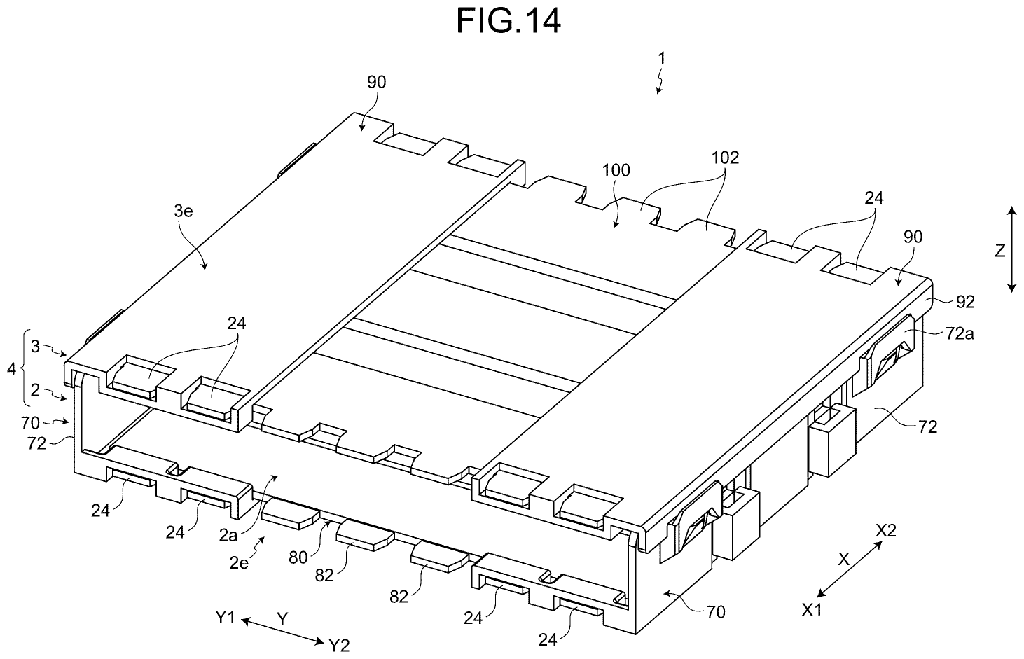

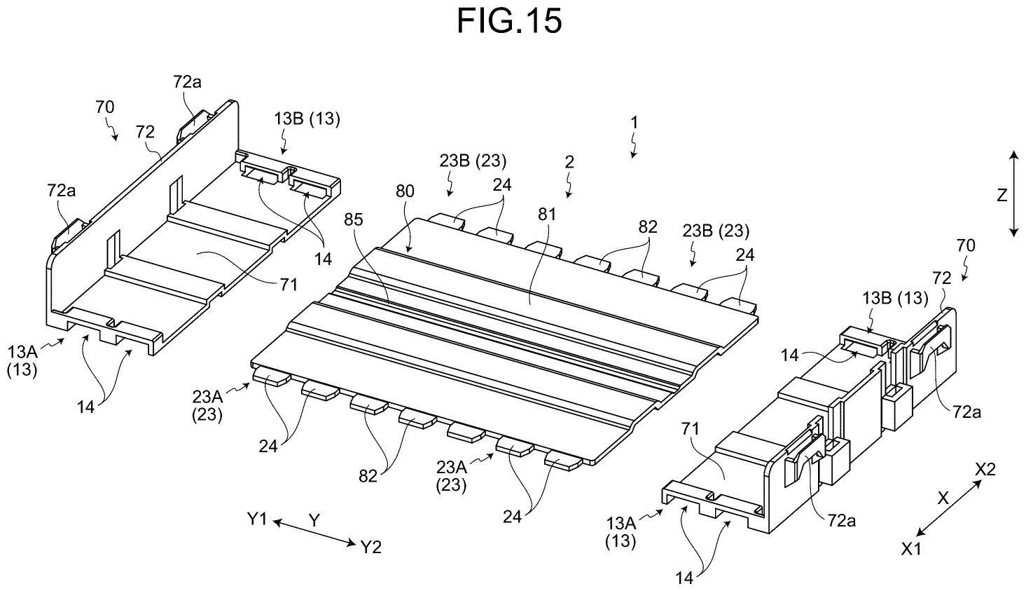

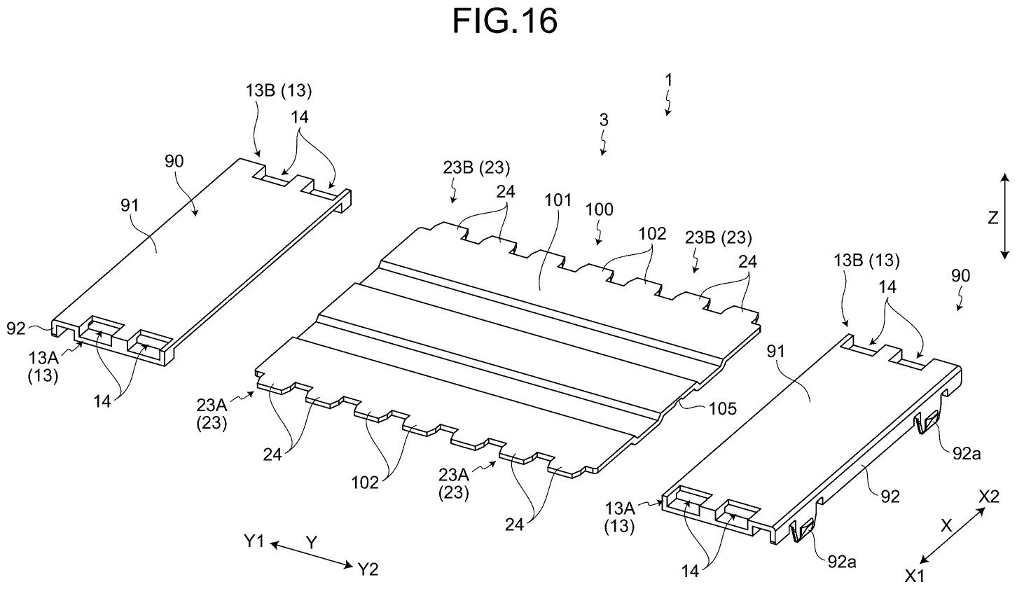

FIG. 11 is a plan view of the wire harness routed in the main body, FIG. 12 is an exploded view of the main body according to the embodiment, FIG. 13 is an exploded view of the cover according to the embodiment, FIG. 14 is a perspective view of the protector according to the embodiment, FIG. 15 is an exploded perspective view of the main body according to the embodiment, and FIG. 16 is an exploded perspective view of the cover according to the embodiment. FIG. 8 illustrates a VIII-VIII cross section taken of FIG. 7.

As illustrated in FIG. 1 and FIG. 2, a protector 1 in the present embodiment includes at least one main body 2 and at least one cover 3. The main body 2 and the cover 3 are formed of, for example, insulative synthetic resin. The main body 2 is a member including a groove section 2a in which a wire harness W is routed. The cover 3 is a member that engages with the main body 2 and covers the groove section 2a. The main body 2 and the cover 3 configure a cylinder section 4 through which the wire harness W is inserted.

As explained below, in the protector 1 in the present embodiment, an assembly 2e or an assembly 3e having different widths can be formed from the same combination of members. The assembly 2e is an assembly that serves as the main body 2 to form the groove section 2a. The assembly 3e is an assembly that serves as the cover 3 to cover the groove section 2a. The protector 1 in the present embodiment is capable of adjusting a size according to the thickness of the wire harness W to be housed while suppressing an increase in the number of product numbers.

As illustrated in FIG. 3 and FIG. 4, the main body 2 includes a first engaging body 10 and a second engaging body 20. The first engaging body 10 and the second engaging body 20 are configured to be engageable with each other. An intermediate engaging body 40 (see FIG. 12) can also be interposed between the first engaging body 10 and the second engaging body 20.

In the main body 2, the first engaging body 10 and the second engaging body 20 are disposed side by side along the width direction Y of the groove section 2a. The first engaging body 10 and the second engaging body 20 may be arranged side by side to partially overlap each other.

In the main body 2 in FIG. 3, the first engaging body 10 is disposed on a first side Y1 in the width direction Y. In the main body 2 in FIG. 3, the second engaging body 20 is disposed on a second side Y2 in the width direction Y. That is, the first engaging body 10 is disposed on the first side Y1 relatively to the second engaging body 20. The second engaging body 20 is disposed on the second side Y2 relatively to the first engaging body 10.

The first engaging body 10 includes a main wall 11, a first side wall 12, and two first engaging sections 13. The main wall 11 is a wall section configuring a bottom wall of the groove section 2a. The shape of the main wall 11 is a substantially flat plate shape. The shape of the main wall 11 in plan view is a rectangular shape. In the main wall 11, an insertion hole 11a into which a clip 6 is inserted is provided. In the main wall 11, a through-hole 11b into which a band member 5 such as a binding band is inserted is provided.

The first side wall 12 is erected from the edge on the first side Y1 in the main wall 11. The first side wall 12 is a side wall forming the groove section 2a and is located at the end portion on the first side Y1 in the main body 2. In the first side wall 12, an engaging section 12a corresponding to an engaging section 33 of the cover 3 and engaging sections 12b and 12c for coupling are provided. In the first side wall 12 in the present embodiment, two engaging sections 12a arranged side by side in an extending direction X of the groove section 2a are provided.

The engaging sections 12b and 12c for coupling are engageable with each other. One engaging section 12b is disposed at an end portion on a first side X1 in the first side wall 12. The other engaging section 12c is disposed at an end portion on a second side X2 in the first side wall 12. The two engaging sections 12b and 12c engage along a height direction Z of the cylinder section 4. The height direction Z is a direction in which the first side wall 12 is erected with respect to the main wall 11 and is a depth direction of the groove section 2a.

The illustrated first engaging sections 13 include a plurality of hole sections 14 opened in an extending direction X. The plurality of hole sections 14 include a first hole section 14a, a second hole section 14b, and a third hole section 14c. The plurality of hole sections 14 are disposed side by side in the width direction Y. The first hole section 14a is located closest to the first side wall 12 among the plurality of hole sections 14. The third hole section 14c is located farthest from the first side wall 12 among the plurality of hole sections 14.

In the following explanation, one of the two first engaging sections 13 is referred to as first engaging section 13A and the other of the two first engaging sections 13 is referred to as first engaging section 13B. The first engaging section 13A is disposed on the first side X1 in the extending direction X. The first engaging section 13B is disposed on the second side X2 in the extending direction X.

The two first engaging sections 13A and 13B are configured such that the hole sections 14 face one another. That is, the hole sections 14 of the first engaging section 13A are opened toward the other first engaging section 13B. The hole sections 14 of the first engaging section 13B are opened toward the other first engaging section 13A.

The second engaging body 20 includes a main wall 21, a second side wall 22, and two second engaging sections 23. The main wall 21 is a wall section configuring the bottom wall of the groove section 2a. The shape of the main wall 21 is a substantially flat plate shape. The shape of the main wall 21 in plan view is a rectangular shape. A part of the main wall 21 of the second engaging body 20 can be superimposed on the main wall 11 of the first engaging body 10. For example, the main wall 21 is superimposed on the main wall 11 to cover the clip 6 disposed in the insertion hole 11a. A through-hole 21b into which the band member 5 is inserted is provided in the main wall 21. The through-hole 21b of the second engaging body 20 is disposed at a position corresponding to the through-hole 11b of the first engaging body 10.

A plurality of through-holes 11b arranged side by side in the width direction Y may be provided in the main wall 11 of the first engaging body 10. For example, in the protector 1 of the present embodiment, the first engaging body 10 and the second engaging body 20 are capable of changing the width of the groove section 2a in three stages. In this case, three through-holes 11b may be provided in the main wall 11. The three through-holes 11b are disposed to face the through-holes 21b in each of the three stages of the width of the groove section 2a.

The second side wall 22 is erected from an edge on the second side Y2 in the main wall 21. The second side wall 22 is a side wall forming the groove section 2a and is located at an end portion on the second side Y2 in the main body 2. When the first engaging sections 13 and the second engaging sections 23 engage, the second side wall 22 faces the first side wall 12 in the width direction Y. An engaging section 22a corresponding to the engaging section 33 of the cover 3 and engaging sections 22b and 22c for coupling are provided in the second side wall 22.

The engaging sections 22b and 22c for coupling are engageable with each other. One engaging section 22b is disposed at an end portion on the first side X1 in the second side wall 22. The other engaging section 22c is disposed at an end portion on the second side X2 in the second side wall 22. The two engaging sections 22b and 22c engage along the height direction Z.

The exemplified second engaging sections 23 include a plurality of protrusions 24 protruding in the extending direction X. The plurality of protrusions 24 include a first protrusion 24a, a second protrusion 24b, and a third protrusion 24c. The plurality of protrusions 24 are disposed side by side in the width direction Y. The first protrusion 24a is located farthest from the second side wall 22 among the plurality of protrusions 24. The third protrusion 24c is located closest to the second side wall 22 among the plurality of protrusions 24.

In the following explanation, one of the two second engaging sections 23 is referred to as second engaging section 23A and the other of the two second engaging sections 23 is referred to as second engaging section 23B. The second engaging section 23A is disposed on the first side X1 in the extending direction X. The second engaging section 23B is disposed on the second side X2 in the extending direction X.

One second engaging section 23 is configured such that the protrusions 24 protrude to the side opposite to the side of the other one second engaging section 23. That is, the protrusions 24 of the second engaging section 23A protrude in a direction away from the other second engaging section 23B. The protrusions 24 of the second engaging section 23B protrude in a direction away from the other second engaging section 23A.

The protrusions 24 of the second engaging sections 23 can be inserted into the hole sections 14 of the first engaging sections 13 along the extending direction X. More specifically, one protrusion 24 of the second engaging sections 23 is engageable with one hole section 14 of the first engaging sections 13. For example, the first protrusion 24a is engageable with any one hole section 14 among the first hole section 14a, the second hole section 14b, and the third hole section 14c. The second protrusion 24b is engageable with the second hole section 14b or the third hole section 14c. The third protrusion 24c is engageable with the third hole section 14c.

The second engaging body 20 includes a flexible section 25 disposed between the two second engaging sections 23A and 23B. The flexible section 25 is provided on the main wall 21 and has flexibility. The exemplified flexible section 25 is molded in a hinge shape having a thin portion. The flexible section 25 may be a groove extending in the width direction Y.

The main wall 21 includes a first region 211 and a second region 212. The first region 211 is disposed on the first side X1 in the extending direction X with respect to the flexible section 25. The second region 212 is disposed on the second side X2 in the extending direction X with respect to the flexible section 25. The flexible section 25 has high flexibility with respect to the first region 211 and the second region 212. Therefore, the second engaging body 20 is capable of bending in a substantially V-shape by deforming the flexible section 25. The protrusions 24 of the second engaging sections 23 are inserted into the hole sections 14 of the first engaging sections 13 in a state in which the second engaging body 20 is bent. When the shape of the second engaging body 20 is restored to the flat plate shape, the engagement of the protrusions 24 with the hole sections 14 is completed.

The second side wall 22 of the second engaging body 20 is divided into two regions 221 and 222 with the flexible section 25 placed therebetween. The first region 221 is disposed on the first side X1 in the extending direction X with respect to the flexible section 25. The second region 222 is disposed on the second side X2 in the extending direction X with respect to the flexible section 25. A gap 22s is provided between the two regions 221 and 222. Since the second side wall 22 is divided into the two regions 221 and 222, the second engaging body 20 is easily deformed.

In the protector 1 in the present embodiment, width Wd1 of the main body 2 changes according to with which of the plurality of hole sections 14 the first protrusion 24a engages. The first protrusion 24a may be engaged with the first hole section 14a as indicated by an alternate long and short dash line in FIG. 4. In this case, the second protrusion 24b engages with the second hole section 14b and the third protrusion 24c engages with the third hole section 14c. FIG. 3 illustrates the main body 2 formed when the first protrusion 24a engages with the first hole section 14a. In this case, a width Wd1 of the main body 2 is the smallest among selectable widths Wd1.

FIG. 5 illustrates the main body 2 in the case in which the first protrusion 24a is engaged with the third hole section 14c. In this case, the second protrusion 24b and the third protrusion 24c are exposed without being inserted into the hole section 14. The width Wd1 of the main body 2 illustrated in FIG. 5 is the largest among the selectable widths Wd1.

The two engaging bodies 10 and 20 may engage with the second protrusion 24b inserted into the third hole section 14c. In this case, the first protrusion 24a is inserted into the second hole section 14b and the third protrusion 24c is exposed without being inserted into the hole section 14. The width Wd1 of the main body 2 in the case in which the second protrusion 24b is engaged with the third hole section 14c is an intermediate size among the selectable widths Wd1.

As illustrated in FIG. 6, the first engaging body 10 and the second engaging body 20 engage with each other to configure the assembly 2e. The assembly 2e is a member in which one first engaging body 10 and one second engaging body 20 are engaged. The assembly 2e forms the groove section 2a. The main body 2 may be configured by coupling a plurality of assemblies 2e. As illustrated in FIG. 6, the two assemblies 2e are coupled by engaging the engaging section 12c included in the other assembly 2e with the engaging section 12b included in one assembly 2e.

As illustrated in FIG. 7, adjacent two assemblies 2e may be fixed by the band member 5. The band member 5 is, for example, a binding band. The band member 5 is inserted into the through-holes 11b and 21b of one assembly 2e and is further inserted into the through-holes 11b and 21b of the other assembly 2e to be bound. The band member 5 can restrict relative displacement of the two assemblies 2e and reinforce the coupling of the two assemblies 2e. The band member 5 can suppress rattling of the first engaging body 10 and the second engaging body 20 in one assembly 2e and firmly couple the two engaging bodies 10 and 20.

As illustrated in FIG. 8, the clip 6 is disposed in the main body 2. The main body 2 is fixed to a metal panel or the like by the clip 6. The clip 6 is inserted into a hole provided in a fixing target wall section and is locked by the wall section. The clip 6 includes an engaging section 61 and a flange section 62. The engaging section 61 is inserted into the hole of the wall section and held by the wall section. The flange section 62 is disposed at a proximal end portion of the engaging section 61. The engaging section 61 of the clip 6 is inserted into the insertion hole 11a of the first engaging body 10. The flange section 62 is locked by the main wall 11 of the first engaging body 10. The flange section 62 is sandwiched between the main wall 11 of the first engaging body 10 and the main wall 21 of the second engaging body 20. The main wall 21 can cover the flange section 62 and suppress interference between the wire harness W and the flange section 62.

As illustrated in FIG. 9, the cover 3 is assembled to the main body 2 along the height direction Z. The cover 3 includes a cover body 31, a pair of side walls 32, and a plurality of engaging sections 33. The cover body 31, the pair of side walls 32, and the engaging sections 33 are, for example, integrally molded. The cover body 31 is a portion covering the groove section 2a of the main body 2 and has a substantially flat plate shape. The side walls 32 are erected from the end portion in the width direction Y in the cover body 31. The side walls 32 of the cover 3 face the first side wall 12 and the second side wall 22 of the main body 2 from the outside. The engaging sections 33 of the cover 3 engage with the engaging sections 12a and 22a of the main body 2 to fix the cover 3 to the main body 2.

In the protector 1 in the present embodiment, one cover 3 is assembled to one assembly 2e. The cover body 31 extends from one end portion to the other end portion in the extending direction X in the assembly 2e and can cover the entire groove section 2a. The cover 3 is assembled to the main body 2 after the wire harness W is routed in the groove section 2a of the main body 2.

The protector 1 may include the cover 3 having a different width corresponding to the width Wd1 of the main body 2. In FIG. 10, a wide cover 3 assembled to a wide main body 2 is illustrated. Since the integrally formed cover 3 is assembled to the main body 2, the formed cylinder section 4 can have appropriate rigidity.

As illustrated in FIG. 11, the wire harness W is routed in the groove section 2a of the main body 2. In the protector 1 in the present embodiment, at least a part of the wire harness W can be drawn out from the gap 22s of the second engaging body 20. For example, as illustrated in FIG. 11, a part of a plurality of electric wires included in the wire harness W is drawn out to the outside from the gap 22s as a branch line WB. When the main body 2 is configured by a plurality of assemblies 2e, the wire harness W can be divided in the assemblies 2e.

As illustrated in FIG. 12, the main body 2 may include an intermediate engaging body 40 interposed between the first engaging body 10 and the second engaging body 20. The intermediate engaging body 40 is a plate-like member and includes both of the first engaging sections 13 and the second engaging sections 23. The intermediate engaging body 40 is a member having a flat plate shape and is formed of, for example, insulative synthetic resin.

The intermediate engaging body 40 includes the first engaging sections 13 and the second engaging sections 23. In the intermediate engaging body 40, the first engaging sections 13 include the plurality of hole sections 14 opened in the extending direction X. The plurality of hole sections 14 include a first hole section 14a, a second hole section 14b, and a third hole section 14c. The plurality of hole sections 14 are disposed side by side in the width direction Y. Like the first engaging body 10, the intermediate engaging body 40 includes the two first engaging sections 13A and 13B. The second engaging section 23A of the second engaging body 20 is engageable with the first engaging section 13A of the intermediate engaging body 40. The second engaging section 23B of the second engaging body 20 is engageable with the first engaging section 13B of the intermediate engaging body 40.

In the intermediate engaging body 40, the second engaging sections 23 include the plurality of protrusions 24 protruding in the extending direction X. The plurality of protrusions 24 include a first protrusion 24a, a second protrusion 24b, and a third protrusion 24c. The plurality of protrusions 24 are disposed side by side in the width direction Y. Like the second engaging body 20, the intermediate engaging body 40 includes the two second engaging sections 23A and 23B. The second engaging section 23A of the intermediate engaging body 40 is engageable with the first engaging section 13A of the first engaging body 10. The second engaging section 23B of the intermediate engaging body 40 is engageable with the first engaging section 13B of the first engaging body 10.

In the main body 2 illustrated in FIG. 12, the intermediate engaging body 40 is interposed between the first engaging body 10 and the second engaging body 20. Accordingly, a maximum value of the width Wd1 selectable in the main body 2 is increased. The width Wd1 can be adjusted in three stages at an engaging part of the first engaging body 10 and the intermediate engaging body 40. Further, the width Wd1 can be adjusted in three stages at an engaging part of the second engaging body 20 and the intermediate engaging body 40. The intermediate engaging body 40 may include the same flexible section as the flexible section of the second engaging body 20. In this case, the flexible section of the intermediate engaging body 40 may be disposed to overlap the flexible section 25 of the second engaging body 20.

Like the main body 2, the cover 3 may be configured to be adjustable in width. For example, as illustrated in FIG. 13, the cover 3 may include a first engaging body 50 and a second engaging body 60. The first engaging body 50 includes a part 31A of the cover body 31, the side wall 32, and two engaging sections 33. The first engaging body 50 includes, for example, the same first engaging sections 13 as the first engaging sections 13 of the main body 2. The first engaging sections 13 include the plurality of hole sections 14 arranged side by side in the width direction Y. The exemplified first engaging body 50 includes the two first engaging sections 13A and 13B.

The second engaging body 60 includes another part 31B of the cover body 31, the side wall 32, and the two engaging sections 33. The second engaging body 60 includes, for example, the same second engaging sections 23 as the second engaging sections 23 of the main body 2. The second engaging sections 23 include the plurality of protrusions 24 arranged side by side in the width direction Y. The exemplified second engaging body 60 includes the two second engaging sections 23A and 23B. The one second engaging section 23A engages with the first engaging section 13A of the first engaging body 50. The other second engaging section 23B engages with the first engaging section 13B of the first engaging body 50.

The second engaging body 60 includes the same flexible section 65 as the flexible section 25 of the second engaging body 20 of the main body 2. The flexible section 65 of the second engaging body 60 is disposed between the two second engaging sections 23A and 23B. The flexible section 65 of the second engaging body 60 is, for example, a groove extending in the width direction Y. A gap corresponding to the flexible section 65 may be provided in the side wall 32 of the second engaging body 60 like the gap 22s of the second engaging body 20.

In the cover 3 illustrated in FIG. 13, the width can be adjusted in a plurality of stages. The first engaging body 50 and the second engaging body 60 engage with each other to configure the assembly 3e. The assembly 3e is an assembly that covers the groove section 2a of the main body 2. Any one of the first engaging body 50 and the second engaging body 60 may be formed not to form a gap in the cover body 31 regardless of the size of the width of the assembly 3e. For example, the part 31A of the cover body 31 in the first engaging body 50 may include an extending section protruding in the width direction Y to always have an overlap with the other part 31B of the cover body 31.

In the protector 1, both of the main body 2 and the cover 3 may be configured such that the widths thereof can be adjusted. In the protector 1 illustrated in FIG. 14, the width of each of the main body 2 and the cover 3 can be adjusted in a plurality of stages. That is, the main body 2 is the assembly 2e forming the groove section 2a and the cover 3 is the assembly 3e covering the groove section 2a.

As illustrated in FIG. 15, the main body 2 includes two first engaging bodies 70 and one second engaging body 80. The two first engaging bodies 70 have the same shape. The first engaging body 70 includes a main wall 71 and a side wall 72. The main wall 71 is a wall section configuring the bottom wall of the groove section 2a. The shape of the main wall 71 is a substantially flat plate shape. The shape of the main wall 71 in plan view is a rectangular shape.

The side wall 72 is erected from an edge in the width direction Y in the main wall 71. The side wall 72 is a side wall forming the groove section 2a. An engaging section 72a that engages with an engaging section 92a of the cover 3 is provided in the side wall 72. The first engaging body 70 include the same first engaging sections 13 as the first engaging sections 13 of the first engaging body 10. The first engaging sections 13 include the plurality of hole sections 14 arranged side by side in the width direction Y. The exemplified first engaging body 70 includes two first engaging sections 13A and 13B.

The second engaging body 80 includes a flat main wall 81. The main wall 81 is a wall section configuring the bottom wall of the groove section 2a. The shape of the main wall 81 in plan view is a rectangular shape. The second engaging body 80 includes the same second engaging sections 23 as the second engaging sections 23 of the second engaging body 20. The second engaging sections 23 include the plurality of protrusions 24 arranged side by side in the width direction Y. Four second engaging sections 23 are provided in the exemplified second engaging body 80.

Among the four second engaging sections 23, the two second engaging sections 23A and 23B are disposed at the end portion on the first side Y1 in the width direction Y. Among the four second engaging sections 23, the other two second engaging sections 23A and 23B are disposed at end portions on the second side Y2 in the width direction Y. A flexible section 85 is provided in the second engaging body 80. The flexible section 85 is disposed between the two second engaging sections 23A and the two second engaging sections 23B and extends in the width direction Y. The second engaging body 80 is capable of bending in a substantially V shape by deforming the flexible section 85. The protrusions 24 of the second engaging body 80 are inserted into the hole sections 14 of the first engaging body 90 in a state in which the second engaging body 80 is bent.

The second engaging section 23A of the second engaging body 80 is engageable with the first engaging section 13A of the first engaging body 70. The second engaging section 23B of the second engaging body 80 is engageable with the first engaging section 13B of the first engaging body 70. The width of the main body 2 can be adjusted in a plurality of stages at an engaging part of the first engaging body 70 and the second engaging body 80. The two first engaging bodies 70 engage with the one second engaging body 80 to configure the assembly 2e.

The cover 3 includes two first engaging bodies 90 and one second engaging body 100. The first engaging body 90 includes a main wall 91 and a side wall 92. The main wall 91 is a wall section covering the groove section 2a. The main wall 91 has a substantially flat plate shape. Main wall 91 has a rectangular shape in plan view. The main wall 91 of the first engaging body 90 faces the main wall 71 of the first engaging body 70.

The side wall 92 is erected from the end portion in the width direction Y in the main wall 91. An engaging section 92a that engages with the engaging section 72a of the main body 2 is provided in the side wall 92. The main wall 91 includes the same first engaging sections 13 as the first engaging sections 13 of the first engaging body 10. The first engaging sections 13 include the plurality of hole sections 14 arranged side by side in the width direction Y. The exemplified first engaging body 90 includes the two first engaging sections 13A and 13B.

The second engaging body 100 includes a flat main wall 101. The second engaging body 100 may have the same shape as the shape of the second engaging body 80 of the main body 2. In this case, components of the main body 2 and the cover 3 can be shared. The main wall 101 configures a wall section covering the groove section 2a. The shape of the main wall 101 in plan view is a rectangular shape. The second engaging body 100 includes the same second engaging sections 23 as the second engaging sections 23 of the second engaging body 20. The second engaging sections 23 include the plurality of protrusions 24 arranged side by side in the width direction Y. Four second engaging sections 23 are provided in the exemplified second engaging body 100.

Among the four second engaging sections 23, the two second engaging sections 23A and 23B are disposed at the end portion on the first side Y1 in the width direction Y. Among the four second engaging sections 23, the other two second engaging sections 23A and 23B are disposed at end portions on the second side Y2 in the width direction Y. A flexible section 105 is provided in the second engaging body 100. The flexible section 105 is disposed between the two second engaging sections 23A and the two second engaging sections 23B and extends in the width direction Y. The second engaging body 100 can be bent in a substantially V shape by deforming the flexible section 105. The protrusions 24 of the second engaging body 100 are inserted into the hole sections 14 of the first engaging body 90 in a state in which the second engaging body 100 is bent.

The second engaging section 23A of the second engaging body 100 is engageable with the first engaging section 13A of the first engaging body 90. The second engaging section 23B of the second engaging body 100 is engageable with the first engaging section 13B of the first engaging body 90. The width of the cover 3 can be adjusted in a plurality of stages at an engaging part of the first engaging body 90 and the second engaging body 100. The two first engaging bodies 90 engages with the one second engaging body 100 to configure the assembly 3e.

As explained above, the protector 1 in the present embodiment includes the assembly 2e forming the groove section 2a in which the wire harness W is routed or the assembly 3e covering the groove section 2a. The assembly 2e includes the first engaging body 10 and the second engaging body 20 or includes the first engaging body 70 and the second engaging body 80. The first engaging bodies 10 and 70 include the first engaging sections 13. The second engaging bodies 20 and 80 are engaging bodies disposed side by side along the width direction Y of the groove section 2a with respect to the first engaging bodies 10 and 70. The second engaging bodies 20 and 80 include the second engaging sections 23 engageable with the first engaging sections 13 along the extending direction X of the groove section 2a.

The first engaging sections 13 and the second engaging sections 23 are configured to be engageable at different relative positions in the width direction Y such that the assembly 2e having a different dimension in the width direction Y can be selectively formed. The first engaging bodies 10 and 70 and the second engaging bodies 20 and 80 can selectively form the assembly 2e having a different dimension in the width direction Y. This makes it possible to manufacture the protector 1 having a different dimension in the width direction Y while achieving sharing of the components.

The assembly 3e includes the first engaging body 50 and the second engaging body 60 or includes the first engaging body 90 and the second engaging body 100. The first engaging bodies 50 and 90 include the first engaging sections 13. The second engaging bodies 60 and 100 are engaging bodies disposed side by side along the width direction Y of the groove section 2a with respect to the first engaging bodies 50 and 90. The second engaging bodies 60 and 100 include the second engaging sections 23 engageable with the first engaging sections 13 along the extending direction X of the groove section 2a.

The first engaging sections 13 and the second engaging sections 23 are configured to be engageable at different relative positions in the width direction Y such that the assembly 3e having a different dimension in the width direction Y can be selectively formed.

The first engaging bodies 50 and 90 and the second engaging bodies 60 and 100 can selectively form the assembly 3e having a different dimension in the width direction Y. This makes it possible to manufacture the protector 1 having a different dimension in the width direction Y while achieving sharing of the components.

In the protector 1 of the present embodiment, the first engaging sections 13 include the hole sections 14 opened in the extending direction X. The second engaging sections 23 include the plurality of protrusions 24 engageable with the hole sections 14. The plurality of protrusions 24 are arranged side by side in the width direction Y. Different protrusions 24 are engageable with the hole sections 14.

For example, in the second engaging sections 23 of the main body 2 illustrated in FIG. 4, the plurality of protrusions 24 are arranged side by side in the width direction Y. Different protrusions 24 are engageable with one hole section 14 of the first engaging sections 13. As an example, any one of the first protrusion 24a, the second protrusion 24b, and the third protrusion 24c is engageable with the third hole section 14c. That is, the first engaging sections 13 and the second engaging sections 23 are engageable at different relative positions in the width direction Y. With such a configuration, the dimension in the width direction Y in the assembly 2e can be adjusted.

In the second engaging sections 23 of the cover 3 illustrated in FIG. 13, the plurality of protrusions 24 are arranged side by side in the width direction Y. Different protrusions 24 are engageable with one hole section 14 of the first engaging sections 13. That is, the first engaging sections 13 and the second engaging sections 23 are engageable at different relative positions in the width direction Y. With such a configuration, the dimension in the width direction Y in the assembly 3e can be adjusted.

In the protector 1 of the present embodiment, the first engaging sections 13 include the plurality of hole sections 14 opened in the extending direction X. The plurality of hole sections 14 are arranged side by side in the width direction Y. The second engaging sections 23 include the protrusions 24 engageable with the hole sections 14. The protrusions 24 are engageable with different hole sections 14.

For example, the first engaging sections 13 of the main body 2 illustrated in FIG. 4 include the plurality of hole sections 14 opened in the extending direction X. The plurality of hole sections 14 are arranged side by side in the width direction Y. The second engaging sections 23 include the protrusions 24 engageable with the hole sections 14. The protrusions 24 are engageable with different hole sections 14. As an example, the first protrusion 24a is engageable with any one of the first hole section 14a, the second hole section 14b, and the third hole section 14c. That is, the first engaging sections 13 and the second engaging sections 23 are engageable at different relative positions in the width direction Y. With such a configuration, the dimension in the width direction Y in the assembly 2e can be adjusted.

The first engaging sections 13 of the cover 3 illustrated in FIG. 13 include the plurality of hole sections 14 opened in the extending direction X. The second engaging sections 23 include the protrusions 24 engageable with the hole sections 14. The protrusions 24 are engageable with different hole sections 14. That is, the first engaging sections 13 and the second engaging sections 23 are engageable at different relative positions in the width direction Y. With such a configuration, the dimension in the width direction Y in the assembly 3e can be adjusted.

The first engaging bodies 10, 50, 70, and 90 in the present embodiment include the two first engaging sections 13A and 13B disposed at different positions in the extending direction X. The second engaging bodies 20, 60, 80, and 100 include two second engaging sections 23A and 23B corresponding to the two first engaging sections 13A and 13B. The first engaging bodies 10, 50, 70, and 90 and the second engaging bodies 20, 60, 80, and 100 are firmly engaged by including two sets of engaging parts.

The second engaging bodies 20, 60, 80, and 100 in the present embodiment include the flexible sections 25, 65, 85, and 105 between the two second engaging sections 23A and 23B. The second engaging bodies 20, 60, 80, and 100 can be bent or curved in the flexible sections 25, 65, 85, and 105. This facilitates work for inserting the protrusions 24 into the hole sections 14.

The protector 1 may include the intermediate engaging body 40 interposed between the first engaging body 10 and the second engaging body 20. The intermediate engaging body 40 includes the second engaging sections 23 engageable with the first engaging sections 13 of the first engaging body 10 and the first engaging sections 13 engageable with the second engaging sections 23 of the second engaging body 20. The protector 1 including the intermediate engaging body 40 can expand a range of selectable widths in the main body 2. The intermediate engaging body 40 may be provided in the cover 3 including the first engaging body 50 and the second engaging body 60. In this case, the intermediate engaging body 40 is interposed between the first engaging body 50 and the second engaging body 60.

The protector 1 includes the main body 2 that is the assembly 2e forming the groove section 2a and the cover 3 that engages with the main body 2 and covers the groove section 2a. The cylinder section 4 through which the wire harness W is inserted is formed by the main body 2 and the cover 3. The cylinder section 4 formed by the main body 2 and the cover 3 is capable of improving the rigidity of the protector 1 and suppressing interference of peripheral components with the wire harness W.

The protector 1 may include the main body 2 that is the assembly 2e forming the groove section 2a and a cover that is the assembly 3e covering the groove section 2a. Since the dimensions of both of the main body 2 and the cover 3 are adjustable, an increase in the number of product numbers is effectively suppressed.

The protector 1 may include assemblies 2e having different lengths. For example, in the main body 2 illustrated in FIG. 6, the length in the extending direction X in one assembly 2e may be larger than the length in the extending direction X in another assembly 2e. In this case, the cover 3 corresponding to the length of the assemblies 2e is assembled to the assemblies 2e.

The number of the hole sections 14 included in the first engaging sections 13 and the shape of the hole sections 14 are not limited to the number and the shape exemplified in the above explanation. For example, the number of the hole sections 14 included in the first engaging sections 13 may be one. In this case, the second engaging sections 23 may include the plurality of protrusions 24 arranged side by side in the width direction Y and any one protrusion 24 among the plurality of protrusions 24 may be engaged with the hole section 14.

The number of the protrusions 24 and the shape of the protrusions 24 included in the second engaging sections 23 are not limited to the number and the shape exemplified in the above explanation. For example, the number of the protrusions 24 included in the second engaging sections 23 may be one. In this case, the first engaging sections 13 may include the plurality of hole sections 14 arranged side by side in the width direction Y and the protrusions 24 may be engaged with any one hole section 14 among the plurality of hole sections 14.

The number of the first engaging sections 13 provided in the first engaging body 10 is not limited to two. For example, the number of the first engaging sections 13 provided in the first engaging body 10 may be one. As an example, the first engaging section 13A may be provided and the first engaging section 13B may not be provided in the first engaging body 10. In this case, the second engaging section 23A may be provided and the second engaging section 23B may not be provided in the second engaging body 20.

When the first engaging body 10 does not include the first engaging section 13B, a positioning structure and a locking structure for the second engaging body 20 may be provided instead of the first engaging section 13B. Examples of the positioning structure and the locking structure include a guide groove and a rail extending in the width direction. In this case, structures corresponding to the guide groove and the rail are provided in the second engaging body 20. With these structures, the two engaging bodies 10 and 20 are positioned and locked in the extending direction X and the height direction Z.

The contents disclosed in the embodiment and the modifications explained above can be appropriately combined and executed as appropriate.

In the protector according to the present embodiment, the first engaging section and the second engaging section are configured to be engageable at different relative positions in the width direction such that the assembly having a different dimension in the width direction can be selectively formed. According to the protector of the present embodiment, it is possible to adjust the size according to the thickness of the wire harness to be accommodated while suppressing an increase in the number of product numbers.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
an assembly that forms a groove section in which a wire harness is routed or an assembly that covers the groove section, wherein
the assembly includes a first engaging body and a second engaging body,
the first engaging body includes a first engaging section,
the second engaging body is an engaging body disposed side by side along a width direction of the groove section with respect to the first engaging body and includes a second engaging section engageable with the first engaging section along an extending direction of the groove section, and
the first engaging section and the second engaging section are configured to be engageable at different relative positions in the width direction such that the assembly having a different dimension in the width direction can be selectively formed.

2. The protector according to claim 1, wherein
the first engaging section includes a hole section opened in the extending direction,
the second engaging section includes a plurality of protrusions engageable with the hole section, the plurality of protrusions being arranged side by side in the width direction, and
the different protrusions are engageable with the hole section.

3. The protector according to claim 1, wherein
the first engaging section includes a plurality of hole sections opened in the extending direction, the plurality of hole sections being arranged side by side in the width direction,
the second engaging section includes a protrusion engageable with the hole sections, and
the protrusion is engageable with the different hole sections.

4. The protector according to claim 1, wherein
the first engaging body includes a pair of the first engaging sections disposed at different positions in the extending direction, and
the second engaging body includes a pair of the second engaging sections corresponding to the two first engaging sections.

5. The protector according to claim 4, wherein
the second engaging body includes a flexible section between the two second engaging sections.

6. The protector according to claim 1, further comprising:
an intermediate engaging body interposed between the first engaging body and the second engaging body in the width direction, wherein
the intermediate engaging body includes the second engaging section engageable with the first engaging section of the first engaging body and the first engaging section engageable with the second engaging section of the second engaging body.

7. The protector according to claim 1, further comprising:
a main body that is the assembly forming the groove section; and
a cover that engages with the main body to cover the groove section, wherein
a cylinder section through which the wire harness is inserted is formed by the main body and the cover.

8. The protector according to claim 1, further comprising:
a main body that is the assembly forming the groove section; and
a cover that is the assembly covering the groove section.
